(19) United States
(12) Patent Application Publication
(10) Pub. No.: US 2016/0356966 A1
(43) Pub. Date: Dec. 8, 2016

(54) FIBER OPTIC ADAPTER ASSEMBLY

(71) Applicants: Gloriole Electroptic Technology Corp., Kaohsiung City (TW); SHEN ZHEN WONDERWIN TECHNOLOGY CO., LTD., Shen Zhen City (CN); Amphenol Fiber Optic Technology (Shenzhen), Shenzhen City (CN)

(72) Inventors: Jim LIN, Kaohsiung City (TW); Chia-Hua WU, Kaohsiung City (TW); Bo-Lin JIANG, Shenzhen City (CN)

(21) Appl. No.: 14/947,532

(22) Filed: Nov. 20, 2015

(30) Foreign Application Priority Data
Jun. 4, 2015 (TW) 104208899

(51) Int. Cl. G02B 6/38; G02B 6/42

(52) U.S. Cl. CPC G02B 6/3879; G02B 6/3825; G02B 6/4277

(57) ABSTRACT

A fiber optic adapter assembly includes at least one first adapter and a plurality of second adapters. The at least one first adapter includes two body parts integrally connected as one piece. Each of the body parts defines two first mounting spaces that extend along an X-direction and that are spaced apart from each other along a Y-direction. The body parts are disposed one above the other along a Z-direction transverse to the X-direction and the Y-direction. Each of the second adapters is connected to a selected one of the body parts of the at least one first adapter.

### CROSS REFERENCE TO RELATED APPLICATION

This application claims priority of Taiwanese Application No. 104208899, filed on Jun. 4, 2015.

### FIELD

The disclosure relates to an adapter for coupling optical fibers, more particularly to a fiber optic adapter assembly.

### BACKGROUND

Referring to FIG. 1, a conventional fiber optic adapter 1 is shown to have a main body 10 defining a receiving space 100. The main body 10 includes a base wall 11, two side walls 12 extending from two opposite ends of the base wall 11 along the same direction, two engaging rods 13 respectively disposed on the side walls 12 at the same ends thereof, two engaging grooves 14 respectively formed in the side walls 12 opposite to the engaging rods 13, and two latching units 15 disposed on the base wall 11 opposite to the side walls 12. The engaging rods 13 are engageable with the engaging grooves 14 of another fiber optic adapter 1. Each latching unit 15 includes a latching member 151 projecting from one end of the base wall 11 away from a respective one of the side walls 12, and a latching groove 152 formed in the respective side wall 12. The latching member 151 is engageable with the latching groove 152 of another fiber optic adapter 1. Through this, a plurality of the fiber optic adapters 1 can be connected in series, as shown in FIG. 2.

FIG. 2 illustrates a plurality of the conventional fiber optic adapters 1 interconnected to form a fiber optic adapter assembly having an array of receiving spaces 100. Each four fiber optic adapters 1 are interconnected through engagement of the engaging rods 13 with the respective engaging grooves 14 to extend along an X-direction. The four interconnected fiber optic adapters 1 can then be connected to another four interconnected fiber optic adapters 1 through engagement of the latching members 151 with the respective latching grooves 152 to extend along a Y-direction transverse to the X-direction, thereby forming eight interconnected fiber optic adapters 1.

However, the aforementioned fiber optic adapters 1 can be interconnected to extend only in the X-direction and the Y-direction, so that the use thereof is limited.

### SUMMARY

Therefore, an object of the present disclosure is to provide an improved fiber optic adapter assembly that is easy to assemble and that can provide a multitude of variations of assembly of adapters.

According to the present disclosure, a fiber optic adapter assembly comprises at least one first adapter and a plurality of second adapters. The at least one first adapter includes two body parts integrally connected as one piece. Each of the body parts defines two first mounting spaces that extend along an X-direction and that are spaced apart from each other along a Y-direction. The body parts are disposed one above the other along a Z-direction transverse to the X-direction and the Y-direction. Each of the second adapters is connected to a selected one of the body parts of the at least one first adapter.

### BRIEF DESCRIPTION OF THE DRAWINGS

Other features and advantages of the disclosure will become apparent in the following detailed description of the embodiments with reference to the accompanying drawings, of which:

FIG. 1 is a perspective view of a conventional fiber optic adapter;

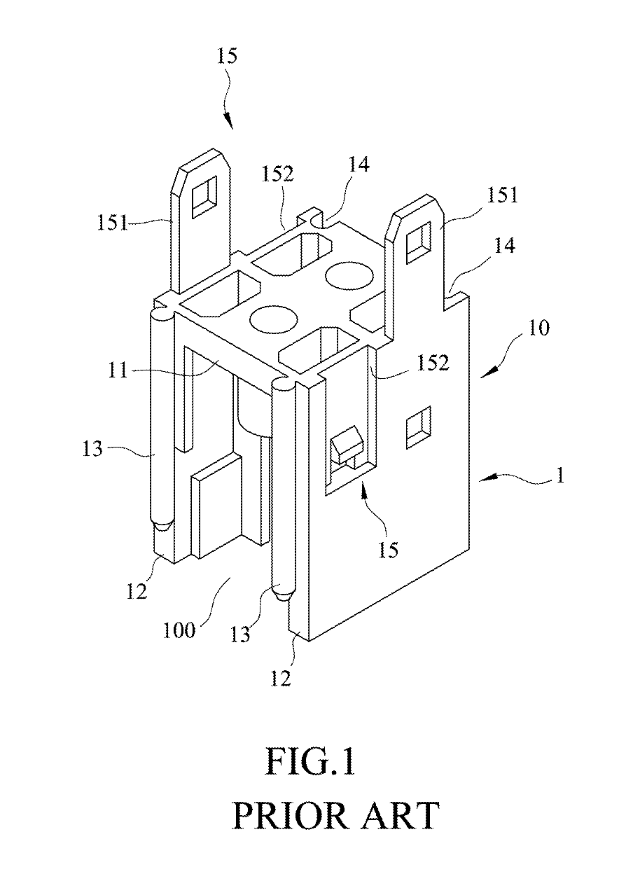

FIG. 2 is a perspective view, illustrating how the conventional fiber optic adapters are interconnected;

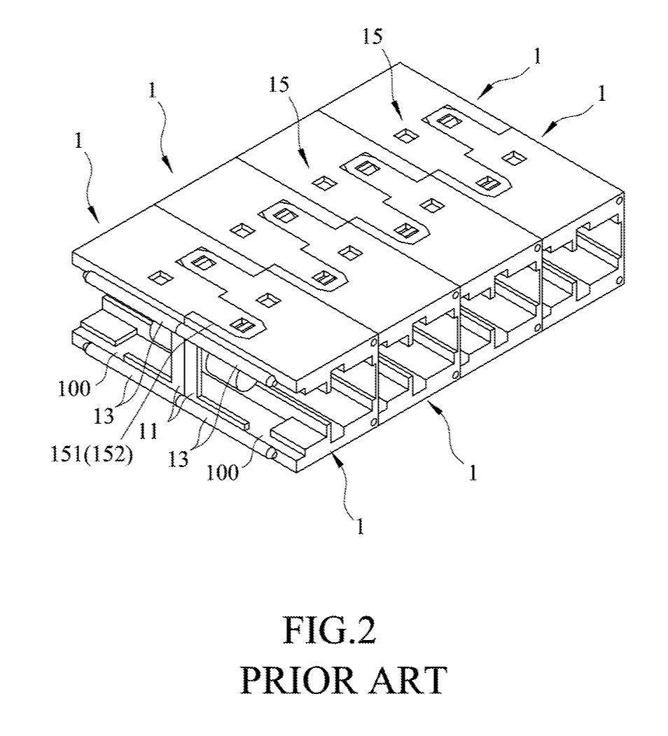

FIG. 3 is a perspective view of a fiber optic adapter assembly according to the first embodiment of the present disclosure;

FIG. 4 is a perspective view of a first adapter of the first embodiment;

FIG. 5 is a view similar to FIG. 4, but taken from another angle;

FIG. 6 is a perspective view of a second adapter of the first embodiment;

FIG. 7 is a view similar to FIG. 6, but taken from another angle;

FIG. 8 is a perspective view of an electromagnetic wave shielding unit of the first embodiment;

FIG. 9 is an exploded perspective view, illustrating how the first and second adapters of the first embodiment can be connected to each other;

FIG. 10 illustrates how two second adapters are connected to two opposite sides of one of two body parts of the first adapter;

FIG. 11 is a view similar to FIG. 10, but with one of the second adapters being connected to one side of the other body part of the first adapter;

FIG. 12 illustrates how two first adapters are connected to each other;

FIG. 13 illustrates another variation of FIG. 12;

FIG. 14 illustrates how two second adapters are connected to each other;

FIG. 15 illustrates how two groups of assembly of the adapters shown in FIG. 9 can be stacked to form a semi-finished adapter assembly;

FIG. 16 is a perspective view of a fiber optic adapter assembly according to the second embodiment of the present disclosure;

FIG. 17 is a perspective view of an end adapter of the second embodiment;

FIG. 18 is a perspective view of another end adapter of the second embodiment;

FIG. 19 is a perspective view of an electromagnetic wave shielding unit of the second embodiment;

FIG. 20 is a view similar to FIG. 19, but taken from another angle;

FIG. 21 illustrates how the end adapter of FIG. 17 is connected to the first adapter;

FIG. 22 illustrates how the end adapter of FIG. 17 is connected to the second adapter;

FIG. 23 illustrates how the end adapter of FIG. 18 is connected to the first adapter;

FIG. 24 illustrates how the end adapter of FIG. 18 is connected to the second adapter;

FIG. 25 is a perspective view of a fiber optic adapter assembly according to the third embodiment of the present disclosure;

FIG. 26 is a perspective view of a third adapter of the third embodiment;

FIG. 27 is a view similar to FIG. 26, but taken from another angle;

FIG. 28 illustrates how the third adapter is connected to the first adapter;

FIG. 29 illustrates how the third adapter is connected to the second adapter;

FIG. 30 illustrates how the third adapter is connected to the end adapter of FIG. 17; and

FIG. 31 illustrates how the third adapter is connected to the end adapter of FIG. 18.

### DETAILED DESCRIPTION

Before the present disclosure is described in greater detail with reference to the accompanying embodiments, it should be noted herein that like elements are denoted by the same reference numerals throughout the disclosure.

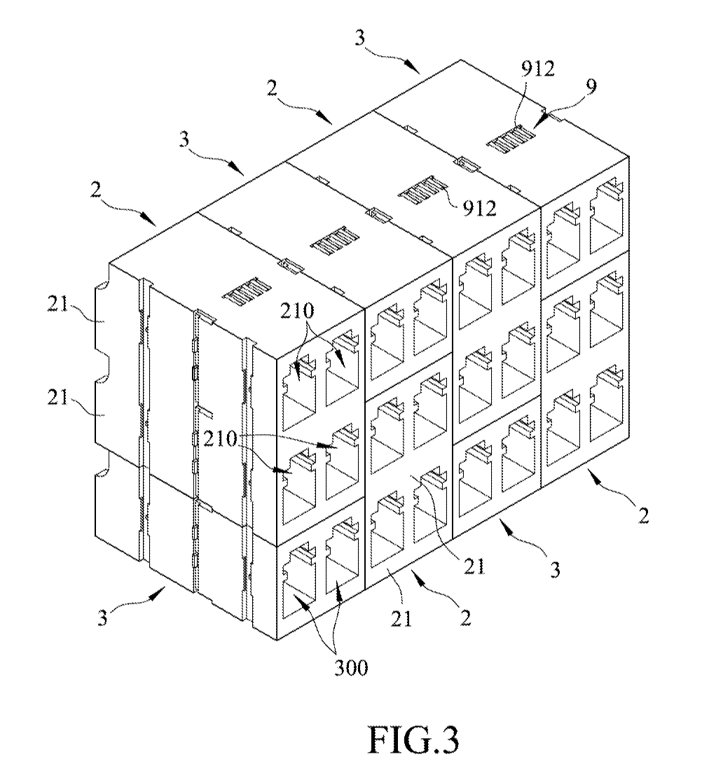

Referring to FIG. 3, a fiber optic adapter assembly according to the first embodiment of the present disclosure is shown to comprise a plurality of first adapters 2, a plurality of second adapters 3 and an electromagnetic wave shielding unit 9.

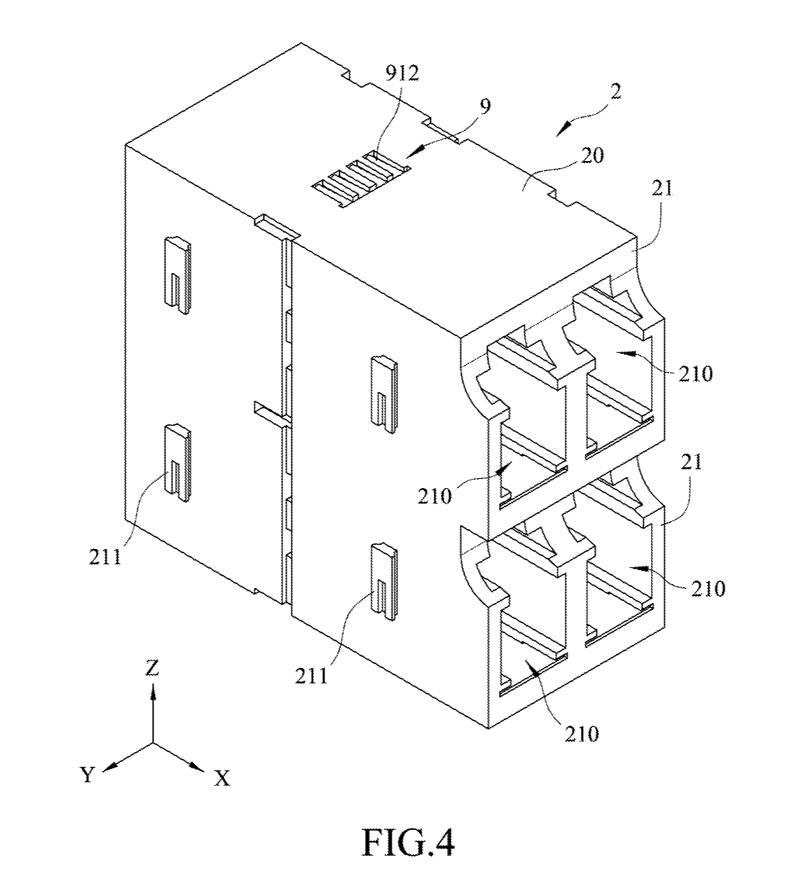

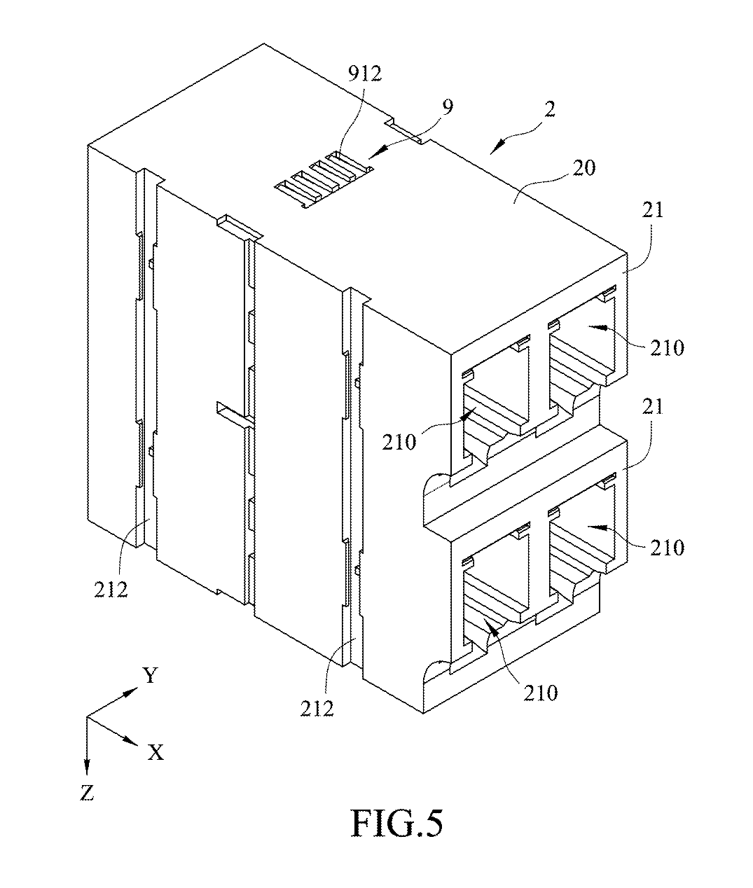

Referring to FIGS. 4 and 5, each first adapter 2 has a first adapter body 20 including two body parts 21 integrally connected as one piece. Each of the body parts 21 defines two first mounting spaces 210 extending along an X-direction and spaced apart along a Y-direction transverse to the X-direction. The body parts 21 are disposed one above the other along a Z-direction transverse to the X-direction and the Y-direction. Each body part 21 has two protrusions 211 provided on one lateral side thereof and spaced apart from each other along the X-direction, and two slide grooves 212 formed in the other lateral side thereof and corresponding in position to the protrusions 211. Each slide groove 212 extends along the Z-direction. The slide grooves 212 of the body parts 21 are respectively aligned with each other along the Z-direction.

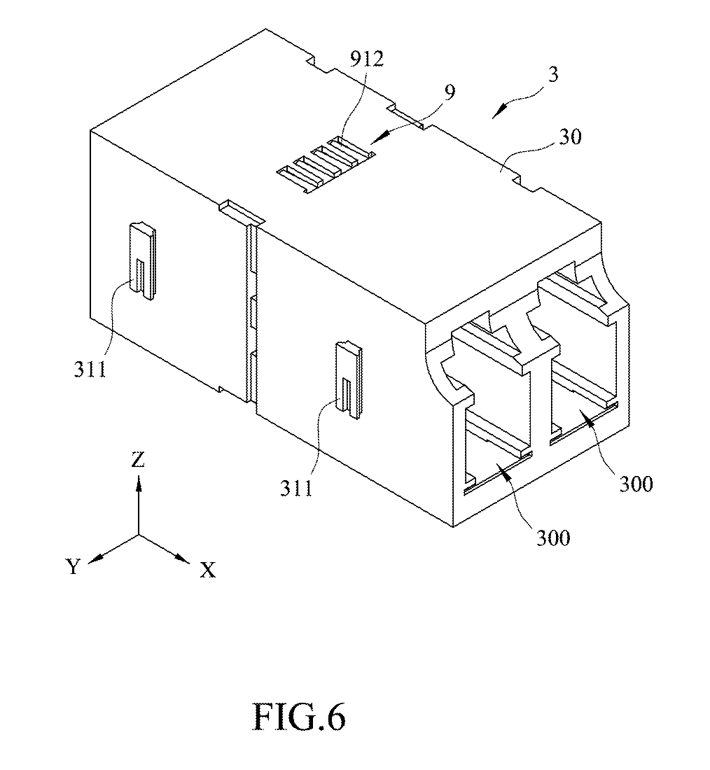

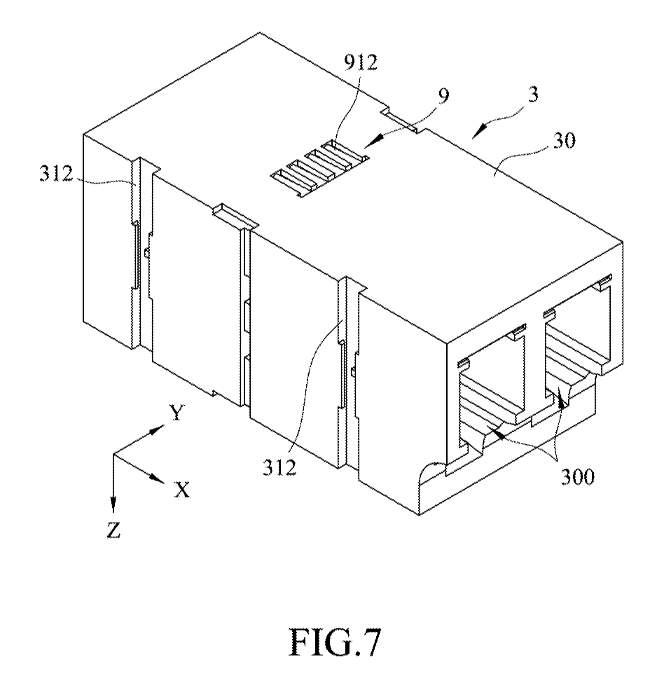

Referring to FIGS. 6 and 7, each second adapter 3 has a second adapter body 30 defining two second mounting spaces 300 that extend along the X-direction and that are spaced apart along the Y-direction, two protrusions 311 provided on one lateral side thereof and spaced apart from each other along the X-direction, and two slide grooves 312 formed in the other lateral side thereof and corresponding in position to the protrusions 311. Each slide groove 312 extends along the Z-direction.

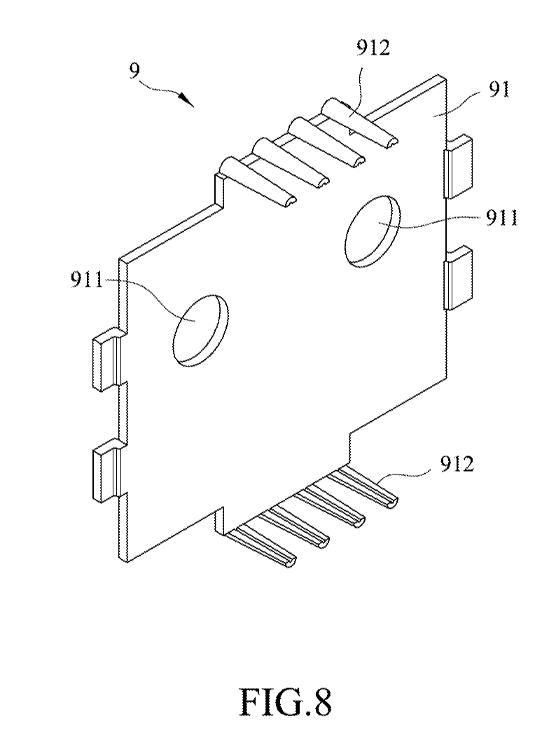

Referring to FIG. 8, in combination with FIGS. 3 to 7, the electromagnetic wave shielding unit 9 includes a plurality of first electromagnetic wave shielding plates 91 respectively embedded in the first and second adapter bodies 20, 30. Each first electromagnetic wave shielding plate 91 is formed with two through holes 911 matching with the first or second mounting spaces 210, 300 for passage therethrough of optical fibers, and has a plurality of pins 912 extending transversely from top and bottom ends thereof. The pins 912 are exposed from top and bottom sides of a corresponding one of the first and second adapter bodies 20, 30. It should be noted herein that, since each of the first and second adapters 2, 3 is made by injection molding, each first electromagnetic wave shielding plate 91 is fixed beforehand on a mold during injection molding of the first or second adapter 2, 3, so that each first electromagnetic wave shielding plate 91 can be embedded in the first or second adapter body 20, 30 after the injection molding. Each first electromagnetic wave shielding plate 91 extends along the Y-direction. Preferably, two first electromagnetic wave shielding plates 91 are respectively embedded in the body parts of the first adapter 2. Each of the first electromagnetic wave shielding plates 91 can shield electromagnetic waves generated during transmission of data by the optical fibers so as to ensure that all data transmitted by the optical fibers will not be affected by electromagnetic interference.

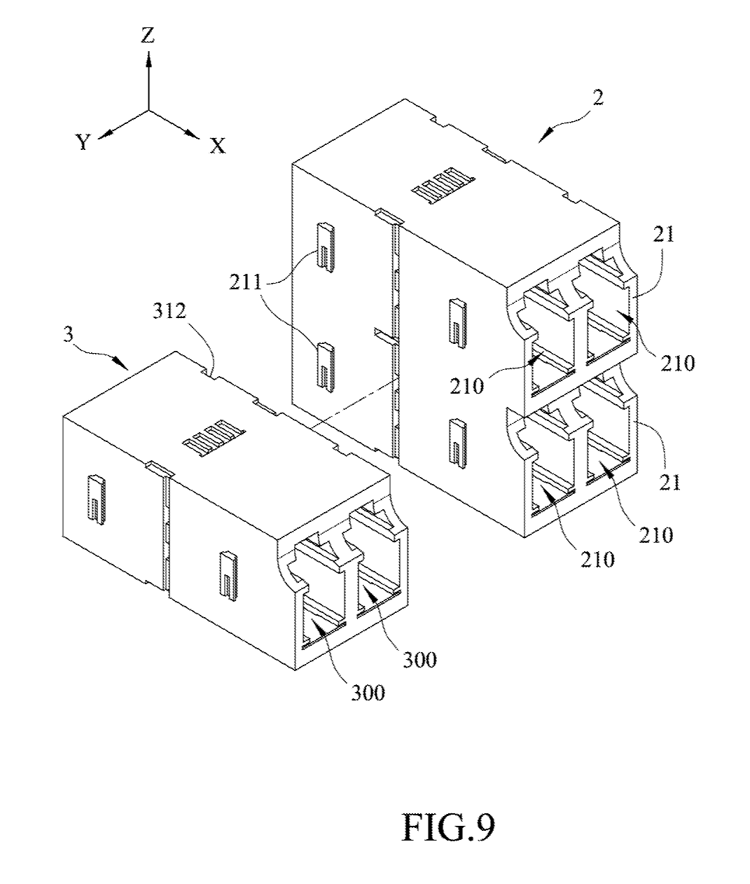

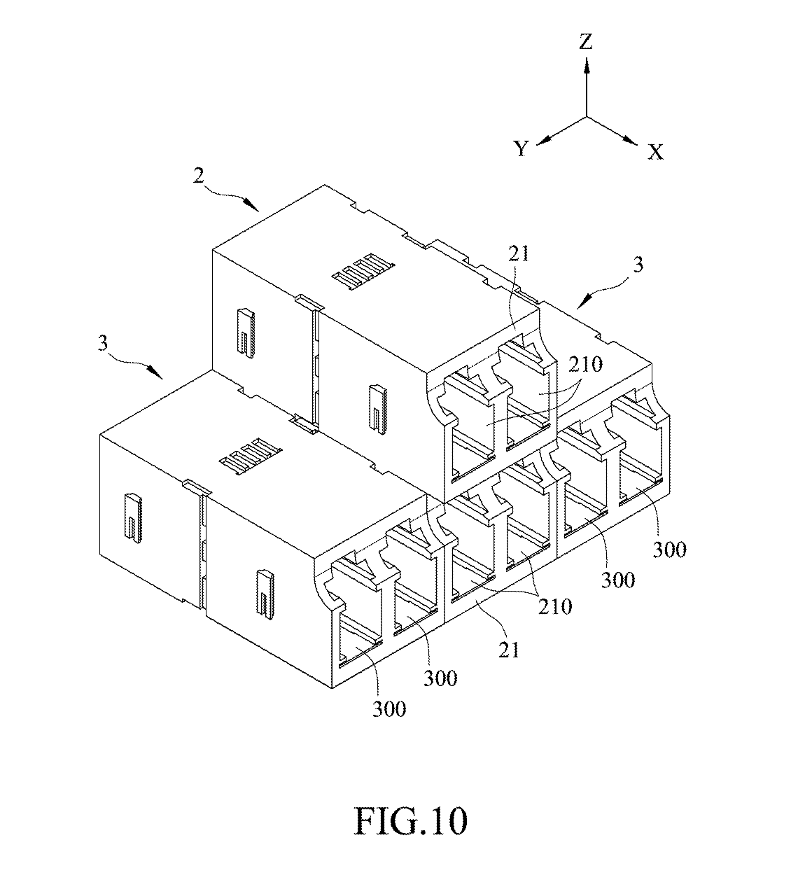

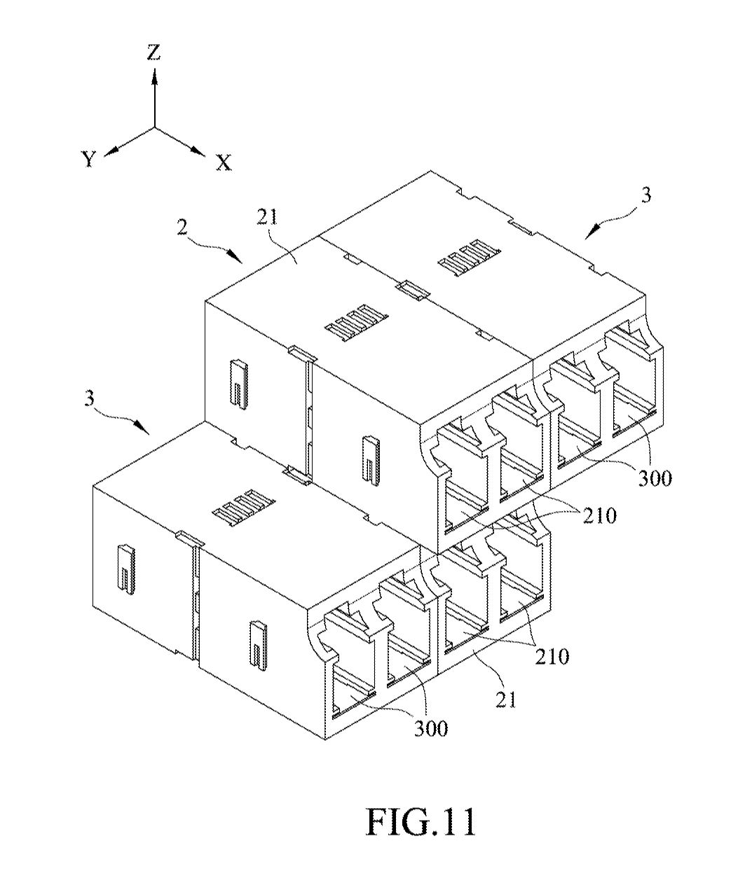

FIG. 9 illustrates a variation of how the first and second adapters 2, 3 can be connected to each other. As shown, the second adapter 3 can be connected side by side to the first adapter 2 along the Y-direction by engaging the slide grooves 312 with the protrusions 211 on a selected one of the body parts 21 of the first adapter 2. FIG. 10 illustrates another variation of connection between the first and second adapters 2, 3. As shown in FIG. 10, two second adapters 3 are connected to two opposite sides of a lower one of the body parts 21 of the first adapter 2. Alternatively, the two second adapters 3 may be connected to two opposite sides of an upper one of the body parts 21 of the first adapter 2 as desired. FIG. 11 illustrates still another variation of connection between the first and second adapters 2, 3. As shown in FIG. 11, one of the second adapters 3 is connected to a left side of the lower body part 21 of the first adapter 2, while the other second adapter 3 is connected to a right side of the upper body part 21 of the first adapter 2.

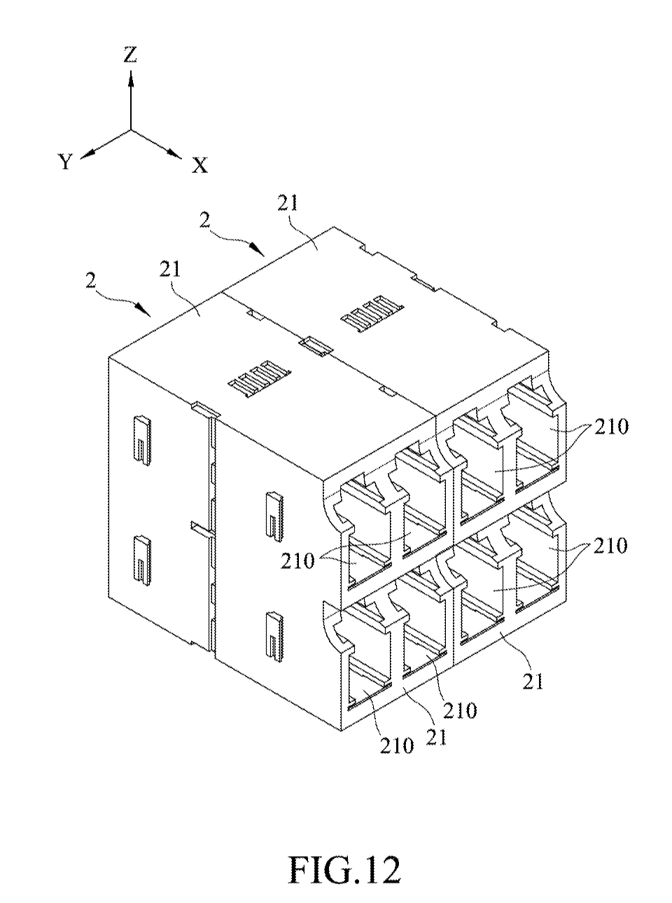

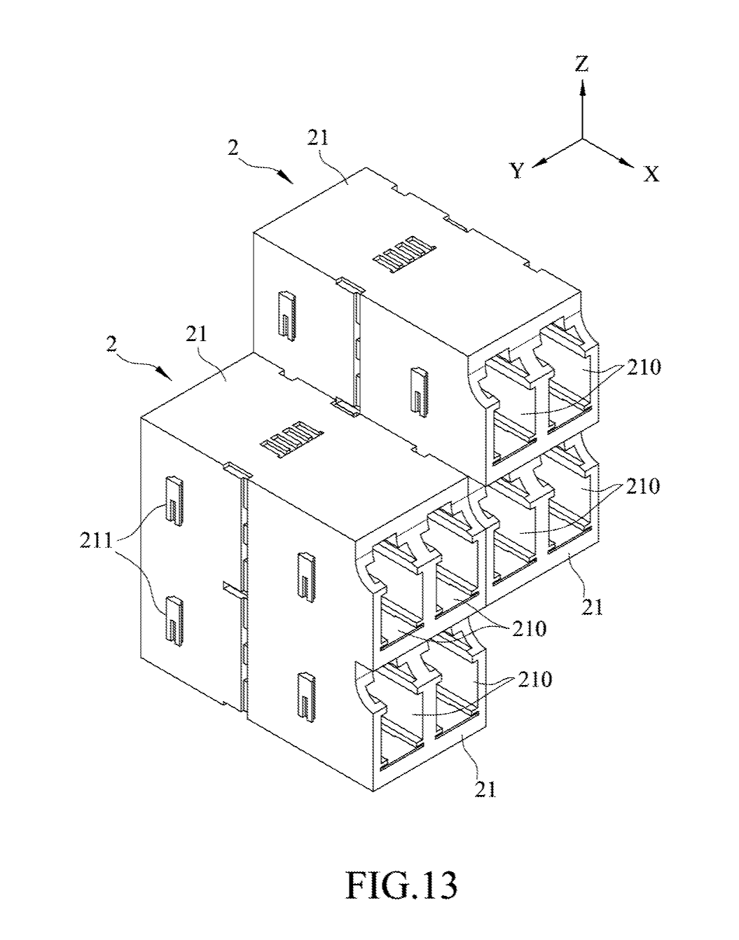

FIG. 12 illustrates two first adapters 2 connected side by side to each other along the Y-direction. As shown, the slide grooves 212 (see FIG. 5) in the body parts 21 of the first adapters 2 are respectively engaged with the protrusions 211 of the body parts 21 of the other first adapter 2. FIG. 13 illustrates a lower body part 21 of a right one of the first adapters 2 connected side by side to a left side of an upper body part 21 of a left one of the first adapters 2.

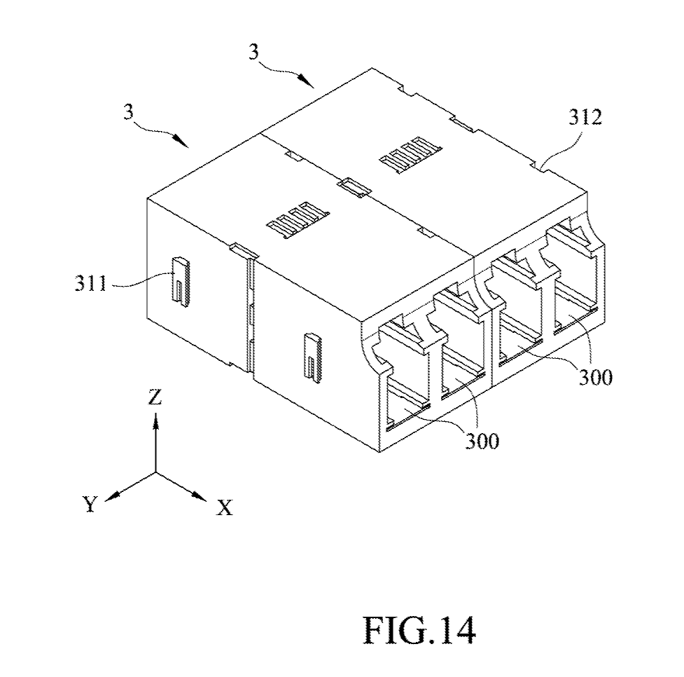

FIG. 14 illustrates two second adapters 3 connected side by side to each other along the Y-direction. As shown, the slide grooves 312 of one of the second adapters 3 are engaged with the second protrusions 311 of the other second adapter 3.

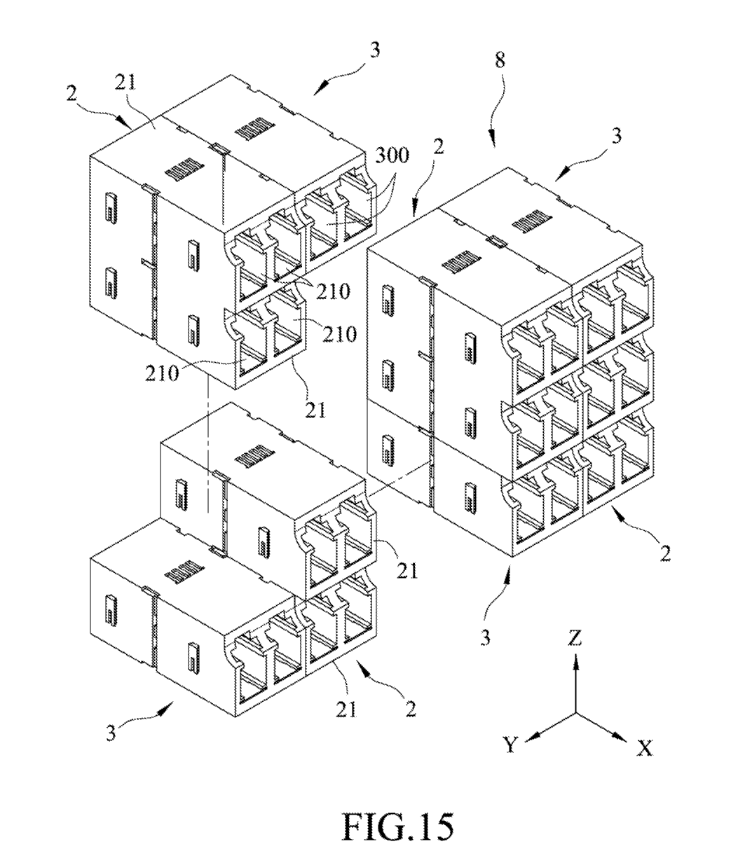

FIG. 15 illustrates how two groups of assembly of the first and second adapters shown in FIG. 9 can be stacked one above the other along the Z-direction to form a semi-finished adapter assembly 8. Moreover, by connecting two semi-finished adapter assemblies 8 along the Y-direction, the adapter assembly of the first embodiment shown in FIG. 3 can be obtained. As shown in FIG. 3, the adapter assembly of the first embodiment has a three-by-eight array of mounting spaces.

It is worth to mention herein that the adapter assembly of the first embodiment shown in FIG. 3 only uses four groups of the assembly of the first and second adapters 2, 3 shown in FIG. 9. If it is further combined with the assemblies of the first and second adapters 2, 3 shown in FIGS. 9 to 14, a multitude of variations of assembly of the adapters can be created. Further, the variations of the assembly of the first and second adapters 2, 3 are not limited to those shown in FIGS. 9 to 15, a user can freely assemble the first and second adapters 2, 3 into various forms of adapter assemblies so as to meet the configuration requirement of a fiber optic network. Moreover, it should be noted herein that the manner of connection between the first and second adapters 2, 3 is not limited to what is disclosed herein.

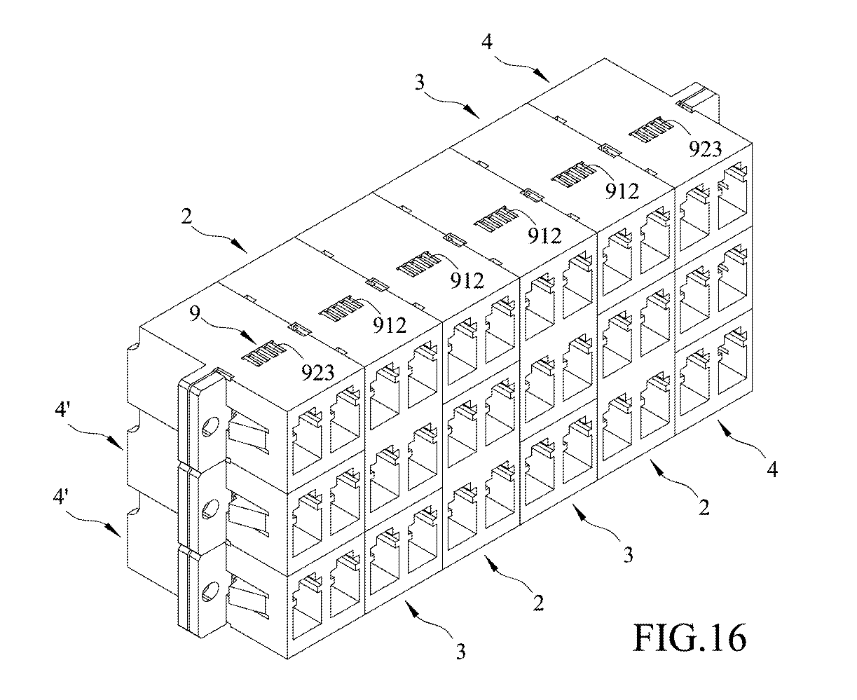

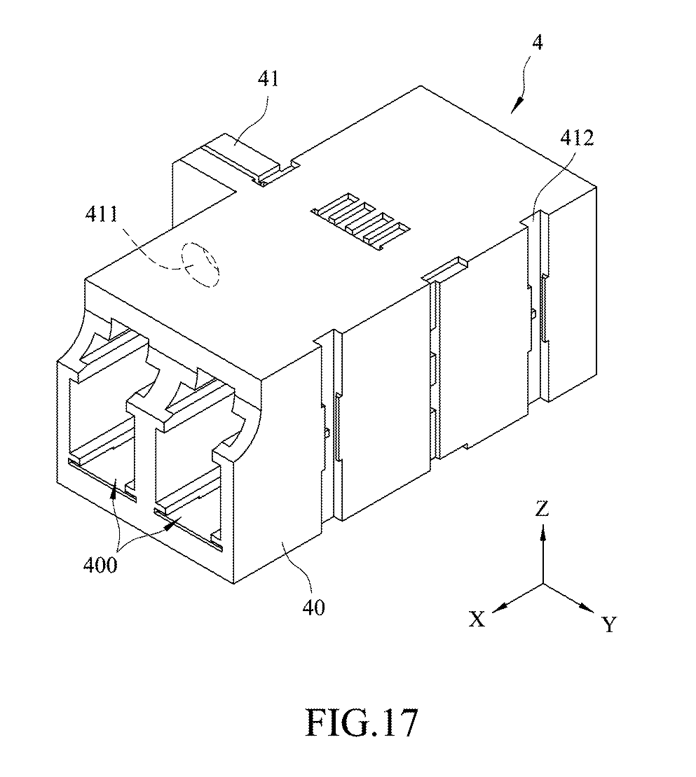

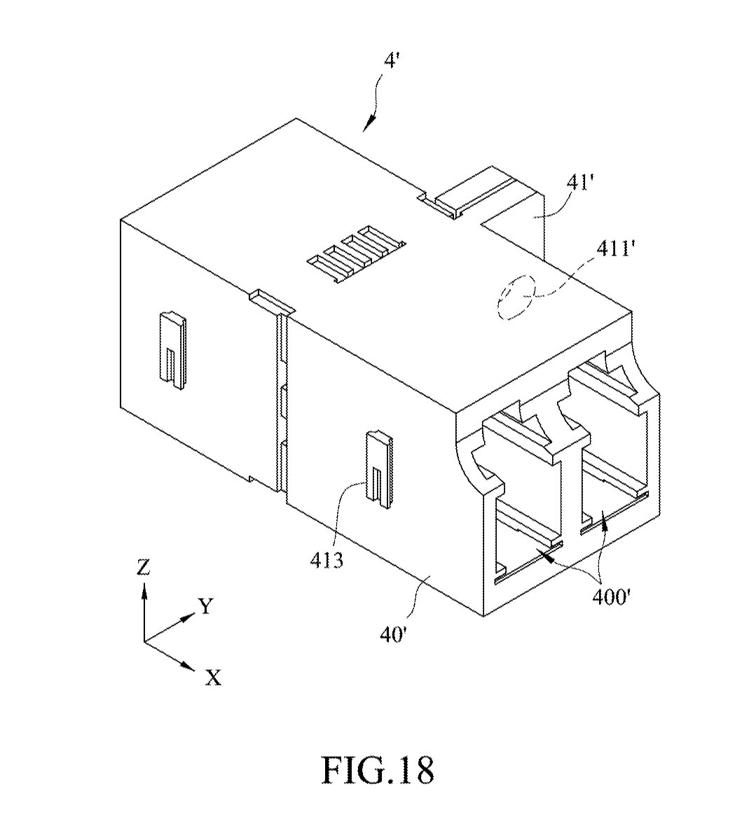

Referring to FIG. 16, a fiber optic adapter assembly according to the second embodiment of the present disclosure is shown to be identical to the first embodiment. However, in this embodiment, the fiber optic adapter assembly further comprises a plurality of end adapters 4, 4′. Each end adapter 4, as shown in FIG. 17, has a third adapter body 40 defining two third mounting spaces 400, a fixing member 41 protruding outwardly from a left lateral side thereof along the Y-direction and formed with a connecting hole 411, and two slide grooves 412 formed in a right lateral side thereof and extending along the Z-direction. The mounting spaces 400 extend along the X-direction, and are spaced apart from each other along the Y-direction. The slide grooves 412 are spaced apart from each other along the X-direction. Each end adapter 4′, as shown in FIG. 18, has a fourth adapter body 40′ defining two fourth mounting spaces 400′, two protrusions 413 provided on one lateral side thereof and spaced apart from each other along the X-direction, and a fixing member 41′ protruding outwardly from the other lateral side thereof along the Y-direction and formed with a connecting hole 411′. The mounting spaces 400′ extend along the X-direction, and are spaced apart from each other along the Y-direction.

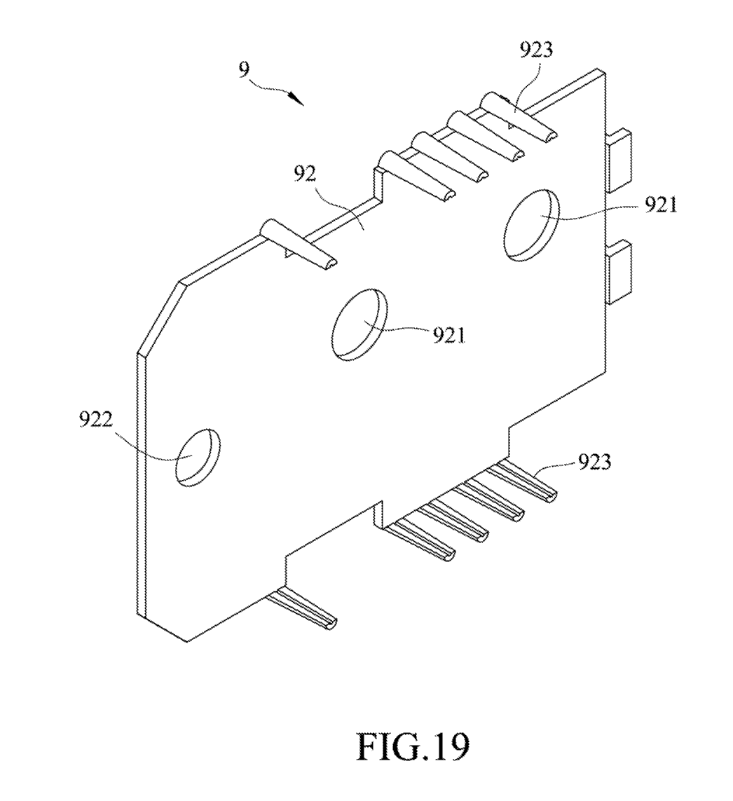

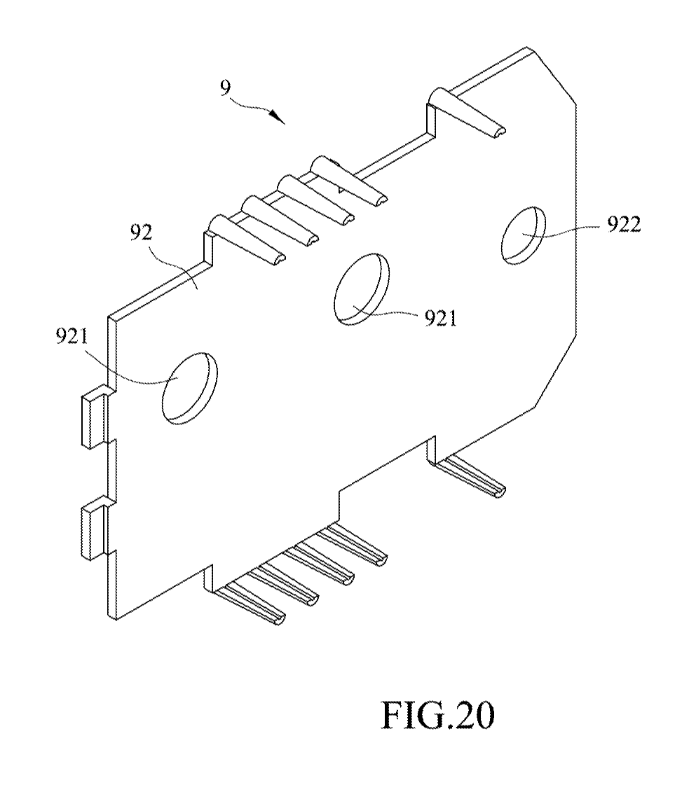

Referring to FIGS. 19 and 20, in combination with FIGS. 17 and 18, the electromagnetic wave shielding unit 9 of the second embodiment further includes a plurality of second electromagnetic wave shielding plates 92 respectively embedded in the third and fourth adapter bodies 40, 40′. Each second electromagnetic wave shielding plate 92 is formed with two through holes 921 matching with the third or fourth mounting spaces 400, 400′ for passage therethrough of optical fibers, and a matching hole 922 matching with the connecting hole 411 in the fixing member 41. Further, each second electromagnetic wave shielding plate 92 has a plurality of pins 923 extending transversely from top and bottom ends thereof and exposed from top and bottom sides of a corresponding one of the third and fourth adapter bodies 40, 40′. Similarly, each second electromagnetic wave shielding plate 92 is also fixed beforehand on a mold during injection molding of the end adapters 4, 4′, so that each second electromagnetic wave shielding plate 92 can be embedded in the respective one of the third and fourth adapter bodies 40, 40′. Each second electromagnetic wave shielding plate 92 extends along the Y-direction, and can similarly shield electromagnetic waves generated during transmission of data by the optical fibers.

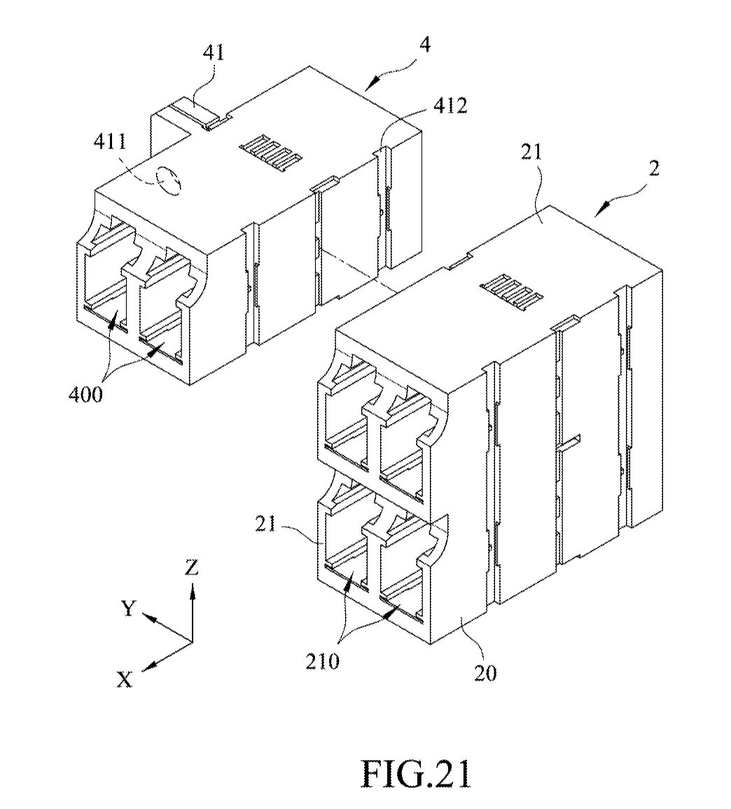

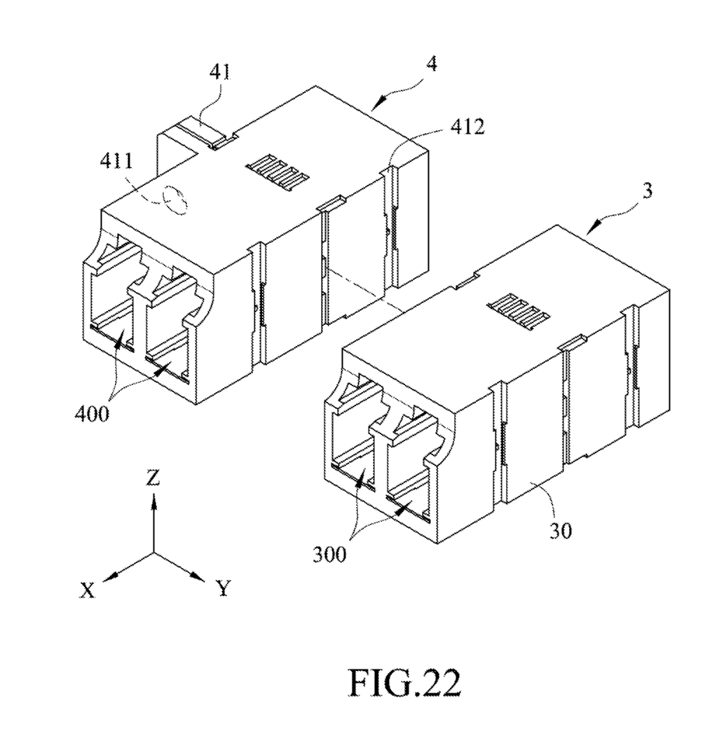

Referring to FIGS. 21 and 22, the end adapter 4 can be connected side by side to the first adapter 2 along the Y-direction by engaging the slide grooves 412 with the protrusions 211 (see FIG. 4) of a selected one of the body parts 21 of the first adapter 2, and can be connected side by side to the second adapter 3 along the Y-direction by engaging the slide grooves 412 with the protrusions 311 (see FIG. 6) of the second adapter 3.

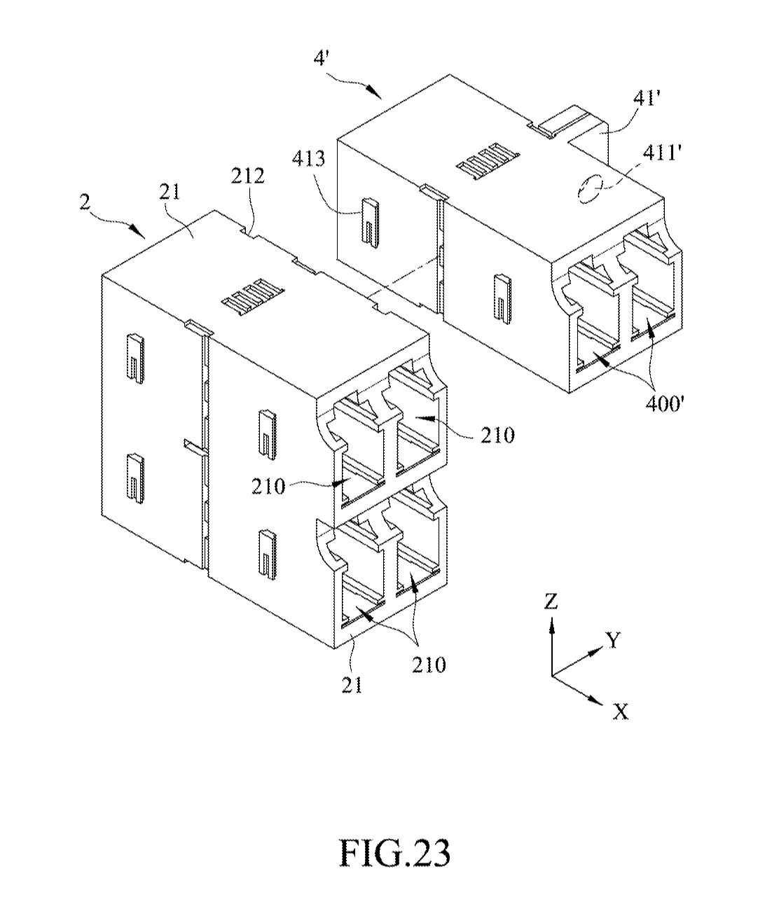

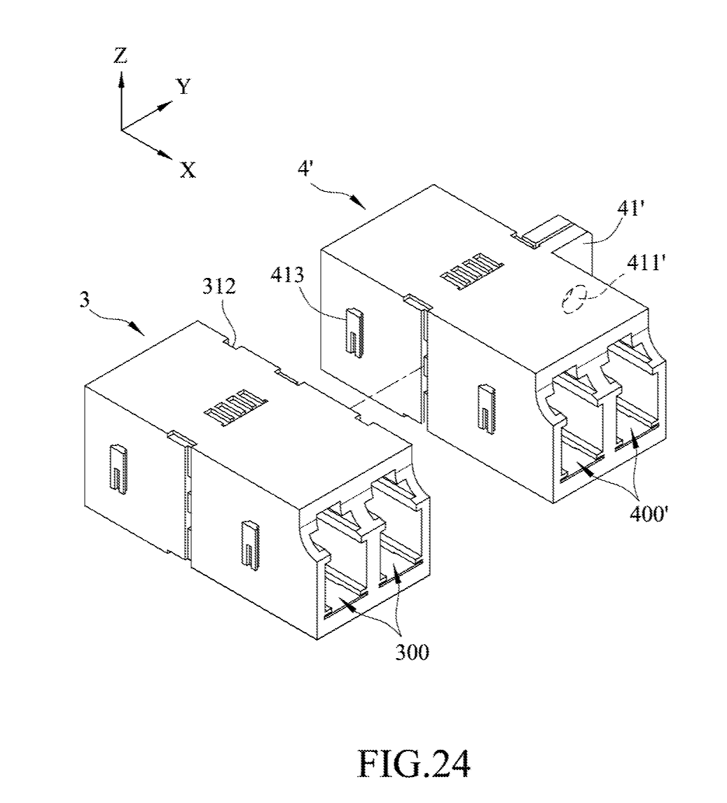

Referring to FIGS. 23 and 24, the end adapter 4′ can be connected side by side to the first adapter 2 along the Y-direction by engaging the protrusions 413 with the slide grooves 212 (see FIG. 5) of a selected one of the body parts 21 of the first adapter 2, and can be connected side by side to the second adapter 3 along the Y-direction by engaging the protrusions 413 with the slide grooves 312 (see FIG. 7) of the second adapter 3.

Therefore, apart from achieving the same effect of the first embodiment, through the connecting holes 411 of the fixing members 41 of the end adapters 4, 4′, the second embodiment can be easily fixed to a specific mounting location.

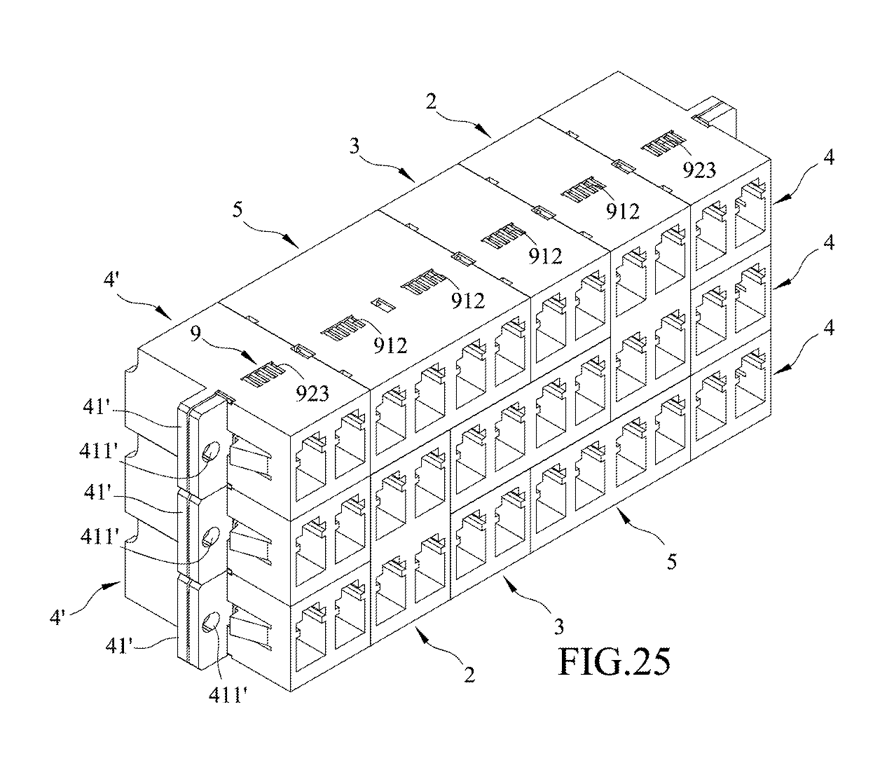

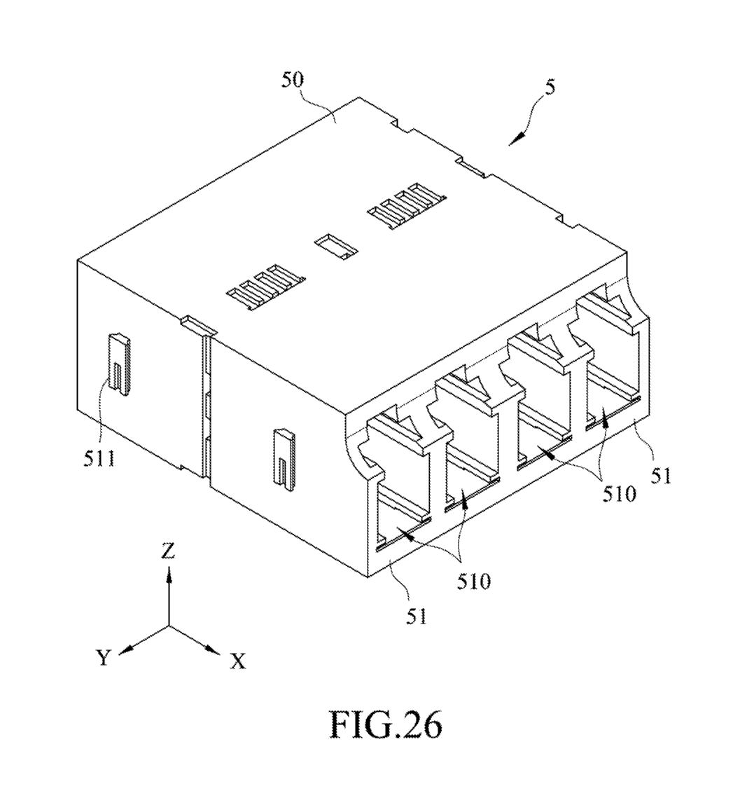

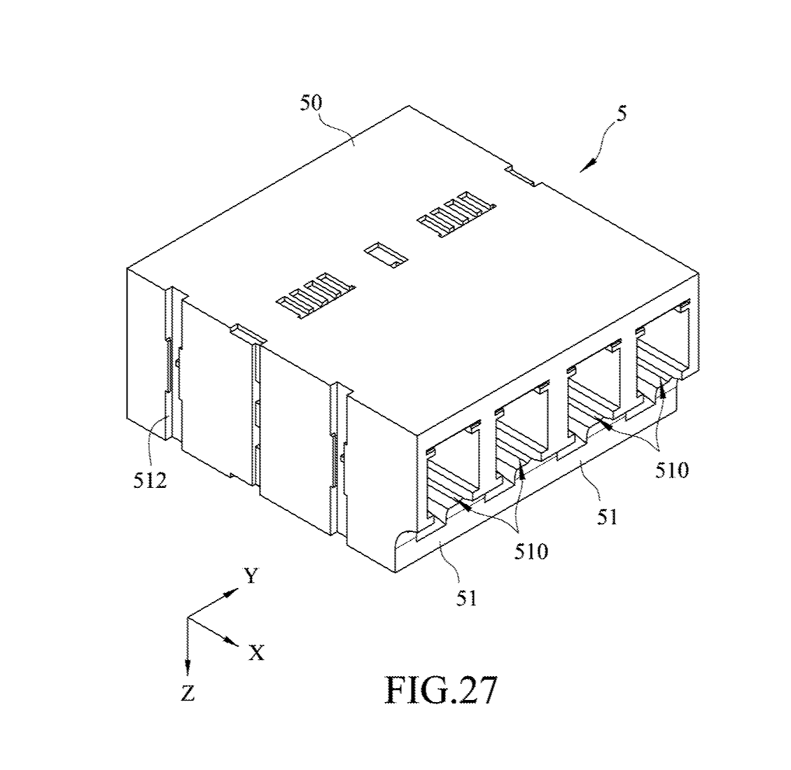

Referring to FIG. 25, a fiber optic adapter assembly according to the third embodiment of the present disclosure is shown to be identical to the second embodiment. However, in this embodiment, the fiber optic adapter assembly further comprises a plurality of third adapters 5. Each third adapter 5, as shown in FIGS. 26 and 27, has a third adapter body 50 including two body parts 51 integrally connected as one piece and disposed side by side along the Y-direction. Each of the body parts 51 defines two fifth mounting spaces 510 extending along the X-direction. The fifth mounting spaces 510 of the body parts 51 are spaced apart from each other along the Y-direction. The third adapter body 50 further includes two protrusions 511 provided on one lateral side thereof and spaced apart from each other along the X-direction, and two slide grooves 512 formed in the other lateral side thereof and corresponding in position to the protrusions 511. Each slide groove 512 extends along the Z-direction.

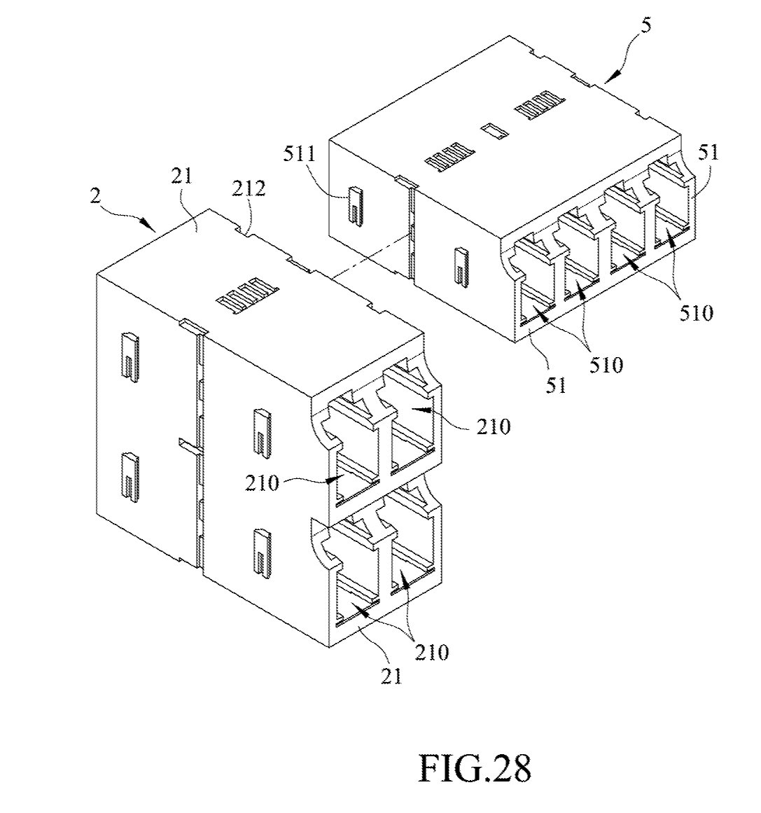

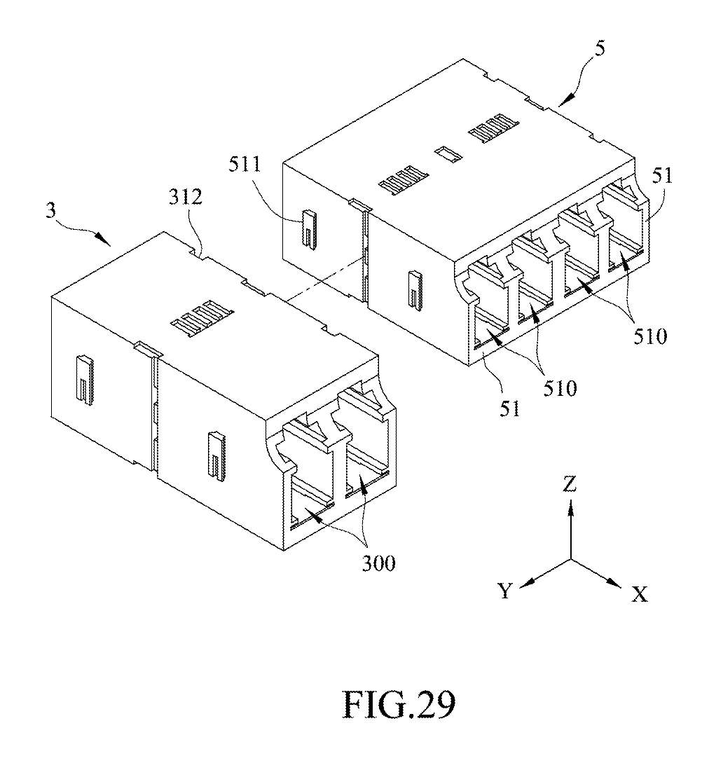

Referring to FIGS. 28 and 29, the third adapter 5 can be connected side by side to the first adapter 2 along the Y-direction by engaging the protrusions 511 with the slide grooves 212 (see FIG. 5) of a selected one of the body parts 21 of the first adapter 2, and can be connected side by side to the second adapter 3 along the Y-direction by engaging the protrusions 511 with the slide grooves 312 (see FIG. 7) of the second adapter 3.

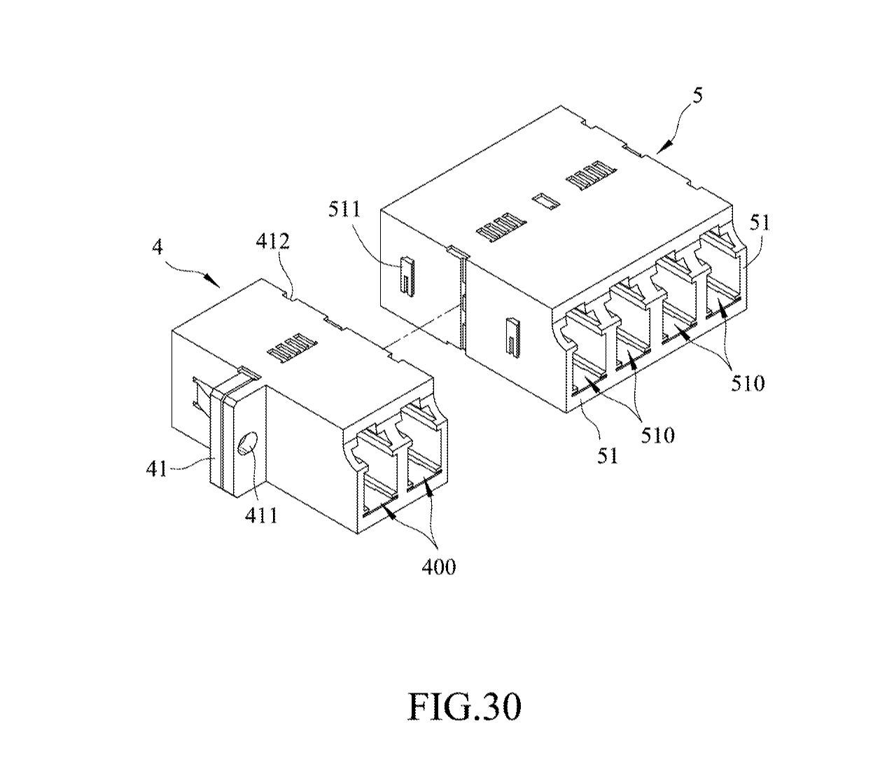

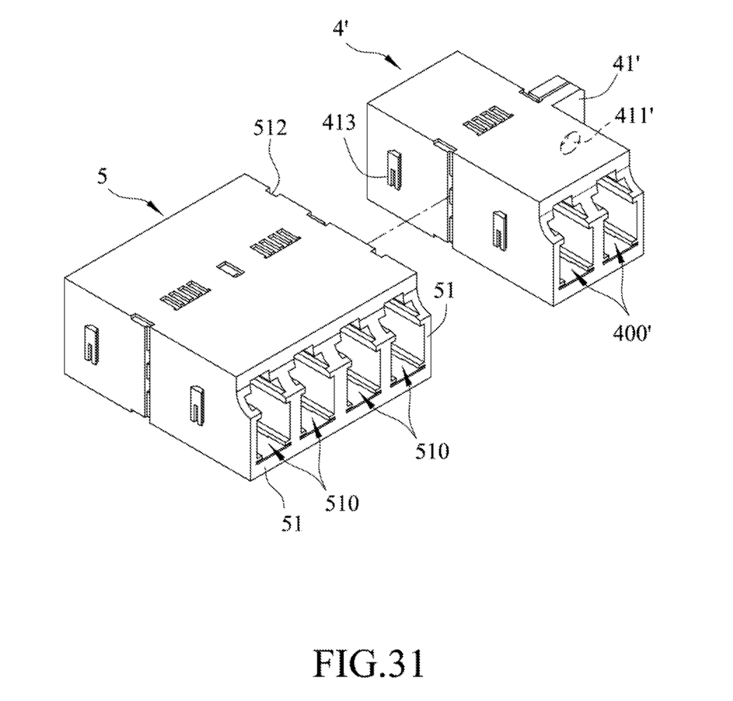

Referring to FIG. 30, the end adapter 4 can be connected side by side to the third adapter 5 along the Y-direction by engaging the slide grooves 412 with the protrusions 511 of the third adapter 5. Referring to FIG. 31, the end adapter 4′ can be connected side by side to the third adapter 5 along the Y-direction by engaging the protrusions 413 with the slide grooves 512 (see FIG. 27) of the third adapter 5.

As shown in FIG. 25, the assembly of the plurality of the first, second and third adapters 2, 3, 5 and the end adapters 4, 4′ results in the fiber optic adapter assembly of the third embodiment having a three-by-twelve array of mounting spaces.

While the disclosure has been described in connection with what are considered the most practical embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A fiber optic adapter assembly comprising:
at least one first adapter including two body parts integrally connected as one piece, each of said body parts defining two first mounting spaces that extend along an X-direction and that are spaced apart from each other along a Y-direction, said body parts being disposed one above the other along a Z-direction transverse to the X-direction and the Y-direction; and
a plurality of second adapters, each of which is connected to a selected one of said body parts of said at least one first adapter.

2. The fiber optic adapter assembly as claimed in claim 1, wherein each of said second adapters defines two second mounting spaces extending along the X-direction and spaced apart from each other along the Y-direction.

3. The fiber optic adapter assembly as claimed in claim 2, wherein each of said second adapters is connected side by side to the selected one of said body parts of said at least one first adapter along the Y-direction.

4. The fiber optic adapter assembly as claimed in claim 2, wherein said at least one first adapter includes a plurality of said first adapters, each two of which are connected to each other along the Y-direction.

5. The fiber optic adapter assembly as claimed in claim 4, wherein one of said body parts of each of said first adapters is connected side by side to a selected one of said body parts of the other one of said first adapters along the Y-direction.

6. The fiber optic adapter assembly as claimed in claim 4, wherein said body parts of each of said first adapters are respectively connected to said body parts of the other one of said first adapters along the Y-direction.

7. The fiber optic adapter assembly as claimed in claim 2, wherein each two of said second adapters are connected to each other along the Y-direction, and said second mounting spaces of said second adapters are spaced apart from each other along the Y-direction.

8. The fiber optic adapter assembly as claimed in claim 2, further comprising a plurality of end adapters respectively connected to said first and second adapters, each of said end adapters defining two third mounting spaces that extend along the X-direction and that are spaced apart from each other along the Y-direction, each of said end adapters being connected to one of said body parts of said at least one first adapter or one of said second adapters along the Y-direction.

9. The fiber optic adapter assembly as claimed in claim 8, wherein each of said end adapters includes a fixing member extending outward along the Y-direction and formed with a connecting hole.

10. The fiber optic adapter assembly as claimed in claim 8, further comprising at least one third adapter connectable to one of said body parts of said at least one first adapter or one of said second adapters along the Y-direction.

11. The fiber optic adapter assembly as claimed in claim 10, wherein said at least one third adapter includes two body parts integrally connected as one piece and disposed side by side along the Y-direction, each of said body parts of said at least one third adapter defining two fourth mounting spaces that extend along the X-direction and that are spaced apart from each other along the Y-direction.

12. The fiber optic adapter assembly as claimed in claim 10, wherein one of said end adapters is connected side by side to said at least one third adapter along the Y-direction.

13. The fiber optic adapter assembly as claimed in claim 11, further comprising an electromagnetic wave shielding unit which includes a plurality of first electromagnetic wave shielding plates respectively embedded in said body parts of said at least one first adapter, said second adapters, and said body parts of said at least one third adapter, and a plurality of second electromagnetic wave shielding plates respectively embedded in said end adapters.

14. The fiber optic adapter assembly as claimed in claim 13, wherein each of said first and second electromagnetic wave shielding plates extends along the Y-direction.
